(19) United States
(12) Patent Application Publication
(10) Pub. No.: US 2024/0275993 A1
(43) Pub. Date: Aug. 15, 2024

(54) METHOD, APPARATUS, AND MEDIUM FOR VIDEO PROCESSING

(71) Applicant: Bytedance Inc., Los Angeles, CA (US)

(72) Inventors: Jizheng XU, Los Angeles, CA (US); Li ZHANG, Los Angeles, CA (US)

(21) Appl. No.: 18/586,214

(22) Filed: Feb. 23, 2024

Related U.S. Application Data
(63) Continuation of application No. PCT/US2022/075591, filed on Aug. 29, 2022.
(60) Provisional application No. 63/239,205, filed on Aug. 31, 2021.

(51) Int. Cl. H04N 19/196

(52) U.S. Cl. CPC H04N 19/196

(57) ABSTRACT

Embodiments of the present disclosure provide a solution for video processing. A method for video processing is proposed. The method comprises: determining, during a conversion between a video unit of a video and a bitstream of the video unit, a first size parameter of an intra block copy (IBC) buffer based on a second size parameter of the video unit, a first value of the first size parameter being an integer multiple of a second value of the second size parameter and the video unit being applied with an IBC mode; and performing the conversion based on the IBC buffer.

### CROSS REFERENCE TO RELATED APPLICATIONS

The application is a continuation of International Patent Application No. PCT/US2022/075591, filed on Aug. 29, 2022, which claims the benefit of U.S. Patent Application No. 63/239,205, filed on Aug. 31, 2021, entitled “INTRA BLOCK COPY BUFFER DESIGN FOR LARGE SIZES OF CTU AND VPDU”. The entire contents of these applications are hereby incorporated by reference in their entireties.

### FIELD

Embodiments of the present disclosure relates generally to video coding techniques, and more particularly, to intra block copy buffer design.

### BACKGROUND

In nowadays, digital video capabilities are being applied in various aspects of peoples' lives. Multiple types of video compression technologies, such as MPEG-2, MPEG-4, ITU-TH.263, ITU-TH.264/MPEG-4 Part 10 Advanced Video Coding (AVC), ITU-TH.265 high efficiency video coding (HEVC) standard, versatile video coding (VVC) standard, have been proposed for video encoding/decoding. However, coding efficiency of video coding techniques is generally expected to be further improved.

### SUMMARY

Embodiments of the present disclosure provide a solution for video processing.

In a first aspect, a method for video processing is proposed. The method comprises: determining, during a conversion between a video unit of a video and a bitstream of the video unit, a first size parameter of an intra block copy (IBC) buffer based on a second size parameter of the video unit, a first value of the first size parameter being an integer multiple of a second value of the second size parameter and the video unit being applied with an IBC mode; and performing the conversion based on the IBC buffer. Compared with conventional technologies, coding efficiency and compression efficiency are improved.

In a second aspect, an apparatus for processing video data is proposed. The apparatus for processing video data comprising a processor and a non-transitory memory with instructions thereon, wherein the instructions upon execution by the processor, cause the processor to determine, during a conversion between a video unit of a video and a bitstream of the video unit, a first size parameter of an intra block copy (IBC) buffer based on a second size parameter of the video unit, a first value of the first size parameter being an integer multiple of a second value of the second size parameter and the video unit being applied with an IBC mode; and perform the conversion based on the IBC buffer. Compared with conventional technologies, coding efficiency and compression efficiency are improved.

In a third aspect, a non-transitory computer-readable storage medium. The non-transitory computer-readable storage medium storing instructions that cause a processor to perform a method. The method comprises: determining, during a conversion between a video unit of a video and a bitstream of the video unit, a first size parameter of an intra block copy (IBC) buffer based on a second size parameter of the video unit, a first value of the first size parameter being an integer multiple of a second value of the second size parameter and the video unit being applied with an IBC mode; and performing the conversion based on the IBC buffer. Compared with conventional technologies, coding efficiency and compression efficiency are improved.

In a fourth aspect, a non-transitory computer-readable recording medium is proposed. The non-transitory computer-readable recording medium storing a bitstream of a video which is generated by a method performed by a video processing apparatus, wherein the method comprises: determining a first size parameter of an intra block copy (IBC) buffer based on a second size parameter of a video unit of the video, a first value of the first size parameter being an integer multiple of a second value of the second size parameter and the video unit being applied with an IBC mode; and generating a bitstream of the video unit based on the IBC buffer.

In a fifth aspect, another method for video processing is proposed. The method for storing bitstream of a video, comprises: determining a first size parameter of an intra block copy (IBC) buffer based on a second size parameter of a video unit of the video, a first value of the first size parameter being an integer multiple of a second value of the second size parameter and the video unit being applied with an IBC mode; generating a bitstream of the video unit based on the IBC buffer; and storing the bitstream in a non-transitory computer-readable recording medium.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

### BRIEF DESCRIPTION OF THE DRAWINGS

Through the following detailed description with reference to the accompanying drawings, the above and other objectives, features, and advantages of example embodiments of the present disclosure will become more apparent. In the example embodiments of the present disclosure, the same reference numerals usually refer to the same components.

FIG. 1 illustrates a block diagram that illustrates an example video coding system, in accordance with some embodiments of the present disclosure;

FIG. 2 illustrates a block diagram that illustrates a first example video encoder, in accordance with some embodiments of the present disclosure;

FIG. 3 illustrates a block diagram that illustrates an example video decoder, in accordance with some embodiments of the present disclosure;

FIG. 4 illustrates a flow chart of a method according to embodiments of the present disclosure; and

FIG. 5 illustrates a block diagram of a computing device in which various embodiments of the present disclosure can be implemented.

Throughout the drawings, the same or similar reference numerals usually refer to the same or similar elements.

### DETAILED DESCRIPTION

Principle of the present disclosure will now be described with reference to some embodiments. It is to be understood that these embodiments are described only for the purpose of illustration and help those skilled in the art to understand and implement the present disclosure, without suggesting any limitation as to the scope of the disclosure. The disclosure described herein can be implemented in various manners other than the ones described below.

In the following description and claims, unless defined otherwise, all technical and scientific terms used herein have the same meaning as commonly understood by one of ordinary skills in the art to which this disclosure belongs.

References in the present disclosure to “one embodiment,” “an embodiment,” “an example embodiment,” and the like indicate that the embodiment described may include a particular feature, structure, or characteristic, but it is not necessary that every embodiment includes the particular feature, structure, or characteristic. Moreover, such phrases are not necessarily referring to the same embodiment. Further, when a particular feature, structure, or characteristic is described in connection with an example embodiment, it is submitted that it is within the knowledge of one skilled in the art to affect such feature, structure, or characteristic in connection with other embodiments whether or not explicitly described.

It shall be understood that although the terms “first” and “second” etc. may be used herein to describe various elements, these elements should not be limited by these terms. These terms are only used to distinguish one element from another. For example, a first element could be termed a second element, and similarly, a second element could be termed a first element, without departing from the scope of example embodiments. As used herein, the term “and/or” includes any and all combinations of one or more of the listed terms.

The terminology used herein is for the purpose of describing particular embodiments only and is not intended to be limiting of example embodiments. As used herein, the singular forms “a”, “an” and “the” are intended to include the plural forms as well, unless the context clearly indicates otherwise. It will be further understood that the terms “comprises”, “comprising”, “has”, “having”, “includes” and/or “including”, when used herein, specify the presence of stated features, elements, and/or components etc., but do not preclude the presence or addition of one or more other features, elements, components and/or combinations thereof.

### Example Environment

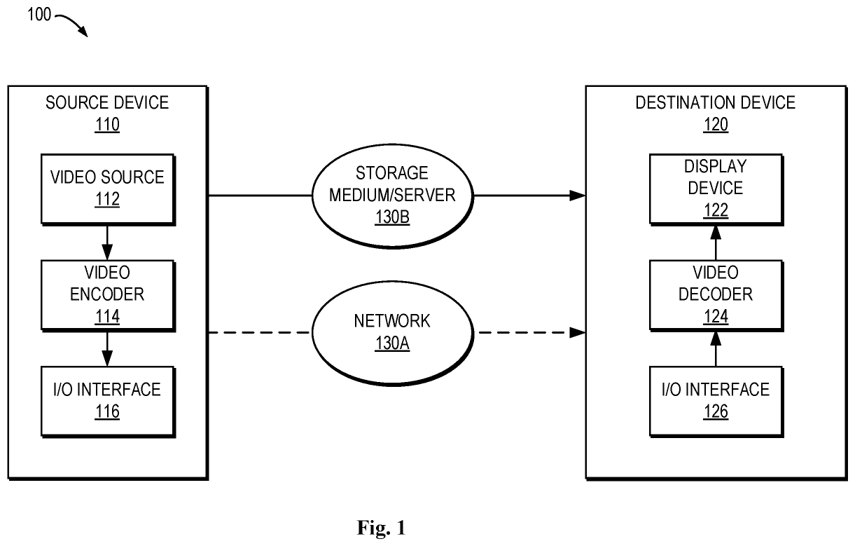

FIG. 1 is a block diagram that illustrates an example video coding system 100 that may utilize the techniques of this disclosure. As shown, the video coding system 100 may include a source device 110 and a destination device 120. The source device 110 can be also referred to as a video encoding device, and the destination device 120 can be also referred to as a video decoding device. In operation, the source device 110 can be configured to generate encoded video data and the destination device 120 can be configured to decode the encoded video data generated by the source device 110. The source device 110 may include a video source 112, a video encoder 114, and an input/output (I/O) interface 116.

The video source 112 may include a source such as a video capture device. Examples of the video capture device include, but are not limited to, an interface to receive video data from a video content provider, a computer graphics system for generating video data, and/or a combination thereof.

The video data may comprise one or more pictures. The video encoder 114 encodes the video data from the video source 112 to generate a bitstream. The bitstream may include a sequence of bits that form a coded representation of the video data. The bitstream may include coded pictures and associated data. The coded picture is a coded representation of a picture. The associated data may include sequence parameter sets, picture parameter sets, and other syntax structures. The I/O interface 116 may include a modulator/demodulator and/or a transmitter. The encoded video data may be transmitted directly to destination device 120 via the I/O interface 116 through the network 130A. The encoded video data may also be stored onto a storage medium/server 130B for access by destination device 120.

The destination device 120 may include an I/O interface 126, a video decoder 124, and a display device 122. The I/O interface 126 may include a receiver and/or a modem. The I/O interface 126 may acquire encoded video data from the source device 110 or the storage medium/server 130B. The video decoder 124 may decode the encoded video data. The display device 122 may display the decoded video data to a user. The display device 122 may be integrated with the destination device 120, or may be external to the destination device 120 which is configured to interface with an external display device.

The video encoder 114 and the video decoder 124 may operate according to a video compression standard, such as the High Efficiency Video Coding (HEVC) standard, Versatile Video Coding (VVC) standard and other current and/or further standards.

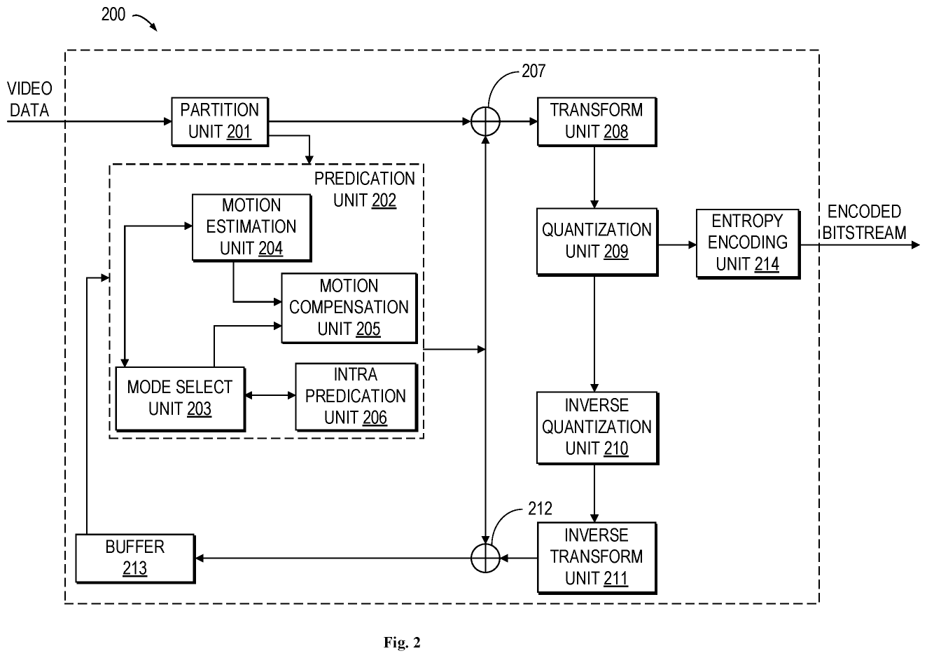

FIG. 2 is a block diagram illustrating an example of a video encoder 200, which may be an example of the video encoder 114 in the system 100 illustrated in FIG. 1, in accordance with some embodiments of the present disclosure.

The video encoder 200 may be configured to implement any or all of the techniques of this disclosure. In the example of FIG. 2, the video encoder 200 includes a plurality of functional components. The techniques described in this disclosure may be shared among the various components of the video encoder 200. In some examples, a processor may be configured to perform any or all of the techniques described in this disclosure.

In some embodiments, the video encoder 200 may include a partition unit 201, a predication unit 202 which may include a mode select unit 203, a motion estimation unit 204, a motion compensation unit 205 and an intra-prediction unit 206, a residual generation unit 207, a transform unit 208, a quantization unit 209, an inverse quantization unit 210, an inverse transform unit 211, a reconstruction unit 212, a buffer 213, and an entropy encoding unit 214.

In other examples, the video encoder 200 may include more, fewer, or different functional components. In an example, the predication unit 202 may include an intra block copy (IBC) unit. The IBC unit may perform predication in an IBC mode in which at least one reference picture is a picture where the current video block is located.

Furthermore, although some components, such as the motion estimation unit 204 and the motion compensation unit 205, may be integrated, but are represented in the example of FIG. 2 separately for purposes of explanation.

The partition unit 201 may partition a picture into one or more video blocks. The video encoder 200 and the video decoder 300 may support various video block sizes.

The mode select unit 203 may select one of the coding modes, intra or inter, e.g., based on error results, and provide the resulting intra-coded or inter-coded block to a residual generation unit 207 to generate residual block data and to a reconstruction unit 212 to reconstruct the encoded block for use as a reference picture. In some examples, the mode select unit 203 may select a combination of intra and inter predication (CIIP) mode in which the predication is based on an inter predication signal and an intra predication signal. The mode select unit 203 may also select a resolution for a motion vector (e.g., a sub-pixel or integer pixel precision) for the block in the case of inter-predication.

To perform inter prediction on a current video block, the motion estimation unit 204 may generate motion information for the current video block by comparing one or more reference frames from buffer 213 to the current video block. The motion compensation unit 205 may determine a predicted video block for the current video block based on the motion information and decoded samples of pictures from the buffer 213 other than the picture associated with the current video block.

The motion estimation unit 204 and the motion compensation unit 205 may perform different operations for a current video block, for example, depending on whether the current video block is in an I-slice, a P-slice, or a B-slice. As used herein, an “I-slice” may refer to a portion of a picture composed of macroblocks, all of which are based upon macroblocks within the same picture. Further, as used herein, in some aspects, “P-slices” and “B-slices” may refer to portions of a picture composed of macroblocks that are not dependent on macroblocks in the same picture.

In some examples, the motion estimation unit 204 may perform uni-directional prediction for the current video block, and the motion estimation unit 204 may search reference pictures of list 0 or list 1 for a reference video block for the current video block. The motion estimation unit 204 may then generate a reference index that indicates the reference picture in list 0 or list 1 that contains the reference video block and a motion vector that indicates a spatial displacement between the current video block and the reference video block. The motion estimation unit 204 may output the reference index, a prediction direction indicator, and the motion vector as the motion information of the current video block. The motion compensation unit 205 may generate the predicted video block of the current video block based on the reference video block indicated by the motion information of the current video block.

Alternatively, in other examples, the motion estimation unit 204 may perform bi-directional prediction for the current video block. The motion estimation unit 204 may search the reference pictures in list 0 for a reference video block for the current video block and may also search the reference pictures in list 1 for another reference video block for the current video block. The motion estimation unit 204 may then generate reference indexes that indicate the reference pictures in list 0 and list 1 containing the reference video blocks and motion vectors that indicate spatial displacements between the reference video blocks and the current video block. The motion estimation unit 204 may output the reference indexes and the motion vectors of the current video block as the motion information of the current video block. The motion compensation unit 205 may generate the predicted video block of the current video block based on the reference video blocks indicated by the motion information of the current video block.

In some examples, the motion estimation unit 204 may output a full set of motion information for decoding processing of a decoder. Alternatively, in some embodiments, the motion estimation unit 204 may signal the motion information of the current video block with reference to the motion information of another video block. For example, the motion estimation unit 204 may determine that the motion information of the current video block is sufficiently similar to the motion information of a neighboring video block.

In one example, the motion estimation unit 204 may indicate, in a syntax structure associated with the current video block, a value that indicates to the video decoder 300 that the current video block has the same motion information as the another video block.

In another example, the motion estimation unit 204 may identify, in a syntax structure associated with the current video block, another video block and a motion vector difference (MVD). The motion vector difference indicates a difference between the motion vector of the current video block and the motion vector of the indicated video block. The video decoder 300 may use the motion vector of the indicated video block and the motion vector difference to determine the motion vector of the current video block.

As discussed above, video encoder 200 may predictively signal the motion vector. Two examples of predictive signaling techniques that may be implemented by video encoder 200 include advanced motion vector predication (AMVP) and merge mode signaling.

The intra prediction unit 206 may perform intra prediction on the current video block. When the intra prediction unit 206 performs intra prediction on the current video block, the intra prediction unit 206 may generate prediction data for the current video block based on decoded samples of other video blocks in the same picture. The prediction data for the current video block may include a predicted video block and various syntax elements.

The residual generation unit 207 may generate residual data for the current video block by subtracting (e.g., indicated by the minus sign) the predicted video block (s) of the current video block from the current video block. The residual data of the current video block may include residual video blocks that correspond to different sample components of the samples in the current video block.

In other examples, there may be no residual data for the current video block for the current video block, for example in a skip mode, and the residual generation unit 207 may not perform the subtracting operation.

The transform processing unit 208 may generate one or more transform coefficient video blocks for the current video block by applying one or more transforms to a residual video block associated with the current video block.

After the transform processing unit 208 generates a transform coefficient video block associated with the current video block, the quantization unit 209 may quantize the transform coefficient video block associated with the current video block based on one or more quantization parameter (QP) values associated with the current video block.

The inverse quantization unit 210 and the inverse transform unit 211 may apply inverse quantization and inverse transforms to the transform coefficient video block, respectively, to reconstruct a residual video block from the transform coefficient video block. The reconstruction unit 212 may add the reconstructed residual video block to corresponding samples from one or more predicted video blocks generated by the predication unit 202 to produce a reconstructed video block associated with the current video block for storage in the buffer 213.

After the reconstruction unit 212 reconstructs the video block, loop filtering operation may be performed to reduce video blocking artifacts in the video block.

The entropy encoding unit 214 may receive data from other functional components of the video encoder 200. When the entropy encoding unit 214 receives the data, the entropy encoding unit 214 may perform one or more entropy encoding operations to generate entropy encoded data and output a bitstream that includes the entropy encoded data.

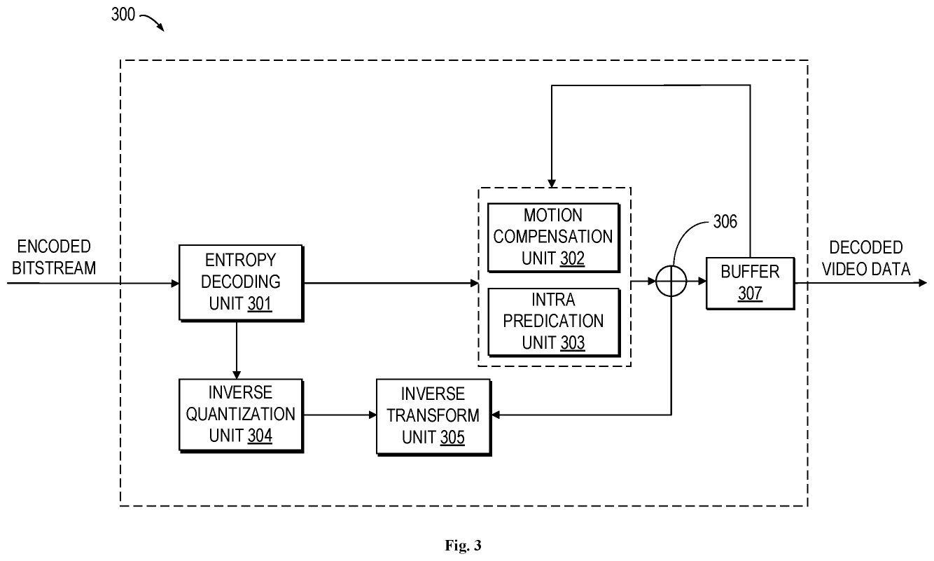

FIG. 3 is a block diagram illustrating an example of a video decoder 300, which may be an example of the video decoder 124 in the system 100 illustrated in FIG. 1, in accordance with some embodiments of the present disclosure.

The video decoder 300 may be configured to perform any or all of the techniques of this disclosure. In the example of FIG. 3, the video decoder 300 includes a plurality of functional components. The techniques described in this disclosure may be shared among the various components of the video decoder 300. In some examples, a processor may be configured to perform any or all of the techniques described in this disclosure.

In the example of FIG. 3, the video decoder 300 includes an entropy decoding unit 301, a motion compensation unit 302, an intra prediction unit 303, an inverse quantization unit 304, an inverse transformation unit 305, and a reconstruction unit 306 and a buffer 307. The video decoder 300 may, in some examples, perform a decoding pass generally reciprocal to the encoding pass described with respect to video encoder 200.

The entropy decoding unit 301 may retrieve an encoded bitstream. The encoded bitstream may include entropy coded video data (e.g., encoded blocks of video data). The entropy decoding unit 301 may decode the entropy coded video data, and from the entropy decoded video data, the motion compensation unit 302 may determine motion information including motion vectors, motion vector precision, reference picture list indexes, and other motion information. The motion compensation unit 302 may, for example, determine such information by performing the AMVP and merge mode. AMVP is used, including derivation of several most probable candidates based on data from adjacent PBs and the reference picture. Motion information typically includes the horizontal and vertical motion vector displacement values, one or two reference picture indices, and, in the case of prediction regions in B slices, an identification of which reference picture list is associated with each index. As used herein, in some aspects, a “merge mode” may refer to deriving the motion information from spatially or temporally neighboring blocks.

The motion compensation unit 302 may produce motion compensated blocks, possibly performing interpolation based on interpolation filters. Identifiers for interpolation filters to be used with sub-pixel precision may be included in the syntax elements.

The motion compensation unit 302 may use the interpolation filters as used by the video encoder 200 during encoding of the video block to calculate interpolated values for sub-integer pixels of a reference block. The motion compensation unit 302 may determine the interpolation filters used by the video encoder 200 according to the received syntax information and use the interpolation filters to produce predictive blocks.

The motion compensation unit 302 may use at least part of the syntax information to determine sizes of blocks used to encode frame(s) and/or slice(s) of the encoded video sequence, partition information that describes how each macroblock of a picture of the encoded video sequence is partitioned, modes indicating how each partition is encoded, one or more reference frames (and reference frame lists) for each inter-encoded block, and other information to decode the encoded video sequence. As used herein, in some aspects, a “slice” may refer to a data structure that can be decoded independently from other slices of the same picture, in terms of entropy coding, signal prediction, and residual signal reconstruction. A slice can either be an entire picture or a region of a picture.

The intra prediction unit 303 may use intra prediction modes for example received in the bitstream to form a prediction block from spatially adjacent blocks. The inverse quantization unit 304 inverse quantizes, i.e., de-quantizes, the quantized video block coefficients provided in the bitstream and decoded by entropy decoding unit 301. The inverse transform unit 305 applies an inverse transform.

The reconstruction unit 306 may obtain the decoded blocks, e.g., by summing the residual blocks with the corresponding prediction blocks generated by the motion compensation unit 302 or intra-prediction unit 303. If desired, a deblocking filter may also be applied to filter the decoded blocks in order to remove blockiness artifacts. The decoded video blocks are then stored in the buffer 307, which provides reference blocks for subsequent motion compensation/intra predication and also produces decoded video for presentation on a display device.

Some exemplary embodiments of the present disclosure will be described in detailed hereinafter. It should be understood that section headings are used in the present document to facilitate ease of understanding and do not limit the embodiments disclosed in a section to only that section. Furthermore, while certain embodiments are described with reference to Versatile Video Coding or other specific video codecs, the disclosed techniques are applicable to other video coding technologies also. Furthermore, while some embodiments describe video coding steps in detail, it will be understood that corresponding steps decoding that undo the coding will be implemented by a decoder. Furthermore, the term video processing encompasses video coding or compression, video decoding or decompression and video transcoding in which video pixels are represented from one compressed format into another compressed format or at a different compressed bitrate.

### 1. SUMMARY

This patent document is related to video coding technologies. Specifically, it is related to intra block copy in video coding. It may be applied to the standard under development or planning, e.g. next generation video coding standards beyond the Versatile Video Coding standard. It may be also applicable to future video coding standards or video codec.

### 2. BACKGROUND

Video coding standards have evolved primarily through the development of the well-known ITU-T and ISO/IEC standards. The ITU-T produced H.261 and H.263, ISO/IEC produced MPEG-1 and MPEG-4 Visual, and the two organizations jointly produced the H.262/MPEG-2 Video and H.264/MPEG-4 Advanced Video Coding (AVC), H.265/HEVC and the latest H.266/Versatile Video Coding (VVC) standards. Since H.261, the video coding standards are based on the hybrid video coding structure wherein temporal prediction plus transform coding are utilized. To explore the future video coding technologies beyond VVC, Joint Video Exploration Team (JVET) started development of the Enhanced Compression Model in April 2021. Since then, many new methods have been adopted by JVET and put into the reference software. The latest software can be found at https://vcgit.hhi.fraunhofer.de/ecm/ECM/-/tags/ECM-2.0.

### 2.1 Virtual Pipeline Data Unit

Virtual pipeline data units (VPDUs) are defined as non-overlapping MxM-luma(L)/N×N-chroma(C) units in a picture. In hardware decoders, successive VPDUs are processed by multiple pipeline stages at the same time; different stages process different VPDUs simultaneously. The VPDU size is roughly proportional to the buffer size in most pipeline stages, so it is very important to keep the VPDU size small. In HEVC hardware decoders, the VPDU size is set to maximum transform block (TB) size. In VVC, the VPDU size is increased to 64×64-luma/32×32-chroma for 4:2:0 format.

### 2.2 Intra Block Copy in VVC

To support Intra Block Copy (IBC) in VVC, a virtual buffer concept is used for reference buffer management. As in JVET-2001-v2 document, given the CTU size, i.e., CtbSizeY0, the buffer width in luma sample is defined as:

IbcBufWidthY=256*128/CtbSizeY

The cossponding chroma IBC buffer is defined as:

IbcBufWidthC=IbcBufWidthY/Sub WidthC,

where SubWidthC depends on chroma format, which is defined in the following table

TABLE 1
SubWidthC and SubHeightC values derived
from sps_chroma_format_idc

| | Chroma | | |
|---|---|---|---|
| sps_chroma_format_idc | format | SubWidthC | SubHeightC |
| 0 | Monochrome | 1 | 1 |
| 1 | 4:2:0 | 2 | 2 |
| 2 | 4:2:2 | 2 | 1 |
| 3 | 4:4:4 | 1 | 1 |

The height of the buffer in luma sample is CtbSize Y.

In VVC, a VPDU concept is applied to enable parallel decoding among different VPDUs within a CTU to increase the decoding throughput. Its size can be derived from CTU size, as in the following table.

TABLE 2
VPDU size derived from CTU size in VVC

| CTU size | VPDU size |
|---|---|
| 128 × 128 | 64 × 64 |
| 64 × 64 | 64 × 64 |
| 32 × 32 | 32 × 32 |

VVC only supports CTU size being 32×32, 64×64 and 128×128. At the beginning of decoding a CTU row in a slice, the luma IBC buffer is reset to be −1. Before decoding a new VPDU, the luma buffer corresponding to that VPDU is also reset to be −1. After finishing decoding a VPDU's data prior to loop filtering, the corresponding buffer samples are updated to the VPDU data that have been just reconstructed.

After a CU has been reconstruted, the reconstructed samples before loop-filtering are stored in the IBC buffer as follows (as described in the text of JVET-T2001-v2):

The following assignments are made for i=0. . nCurrSw−1, j=0. . nCurrSh−1:

$$xVb = ( xCurr + i ) \% ( ( cIdx == 0 ) ? IbcBufWidthY : IbcBufWidthC ) \qquad ( 1197 )$$

$$yVb = ( yCurr + j ) \% ( ( cIdx == 0 ) ? CtbSizeY : ( CtbSizeY / subHeightC ) ) \qquad ( 1198 )$$

$$IbcVirBuf [ cIdx ] [ xVb ] [ yVb ] = recSamples [ xCurr + i ] [ yCurr + j ] \qquad ( 1199 )$$

If a CU uses IBC mode, its prediction is formed as follows:

When cIdx is equal to 0, for x=xCb. . xCb+cbWidth−1 and y=yCb. . yCb+cbHeight−1, the following applies:

$$xVb = ( x + ( bv [ 0 ] >> 4 ) ) \& ( IbcBufWidthY - 1 ) \qquad ( 1096 )$$

$$yVb = ( y + ( bv [ 1 ] >> 4 ) ) \& ( CtbSizeY - 1 ) \qquad ( 1097 )$$

$$predSa mples [ x - xCb ] [ y - yCb ] = IbcVirBuf [ 0 ] [ xVb ] [ yVb ] \qquad ( 1098 )$$

When cIdx is not equal to 0, for x=xCb/SubWidthC. . xCb/SubWidthC+cbWidth/SubWidthC−1 and y=yCb/SubHeightC. . yCb/SubHeightC+cbHeight/SubHeightC−1, the following applies:

$$xVb = ( x + ( bv [ 0 ] >> ( 3 + SubWidthC ) ) ) \& ( IbcBufWidthC - 1 ) \qquad ( 1099 )$$

$$yVb = ( y + ( bv [ 1 ] >> ( 3 + SubHeightC ) ) ) \& ( ( CtbSizeY / subHeightC ) - 1 ) \qquad ( 1100 )$$

$$predSamples [ x - ( xCb / SubWidthC ) ] [ y - yCb / SubHeightC ) ] = IbcVirBuf [ cIdx ] [ xVb ] [ yVb ] \qquad ( 1101 )$$

### 2.3 Enhanced Compression Model

After finishing the 1st version of VVC, JVET started to develop a test model to explore further coding efficiency improvement over VVC. The test model is named Enhanced Compression Model. Many new coding tools, e.g. intra temporal matching, dependent quantization with 8-states, are integrated into the VVC test model to improve the coding efficiency.

It is noted that in ECM, the CTU size can be extended to 256×256. However, the IBC buffer with the extended CTU size and corresponding processing are undefined.

### 2.4 General Virtual Buffer

In an example solution, several bullets are about CTU size being 256×256. They are listed as follows:
11. When CTU/CTB size is 256×256, the corresponding IBC virtual buffer may be of size 64×256 to track availability of reference samples, i.e. ibcBufW=64, ibcBufH=256.
   a. In one example, before decoding a VPDU with top-left position (x0, y0), the corresponding VPDU row (0, y0%256) in the IBC buffer will be set to −1.
12. When CTU/CTB size is 256×256, the corresponding IBC virtual buffer may be of size 128×256 to track availability of reference samples, i.e. ibcBufW=128, ibcBufH=256.
   a. In one example, only one VPDU may be kept (excluding the current VPDU) for each VPDU row in the buffer except for a certain VPDU row.
      i. In one example, only one VPDU may be kept (excluding the current VPDU) for each VPDU row in the buffer except for the last VPDU row.

This documents present more systematic and general design to handle large CTU.

### 3. Potential Problems

In the current design of IBC buffer design, there are some issues and improvement to alleviate those is possible.
1) The current IBC buffer design only supports CTU size being 128, 64 or 32. It does not support CTU size larger than 128, e.g. 256 in ECM.
2) The current IBC buffer design does not support VPDU size larger than 64×64.
3) The current IBC buffer design does not support non-square CTU.
4) The current IBC buffer design does not support non-square VPDU.

### 4. EMBODIMENTS OF THE PRESENT DISCLOSURE

To solve the above problems, methods as summarized below are disclosed. Embodiments should be considered as examples to explain the general concepts and should not be interpreted in a narrow way. Furthermore, these embodiments can be applied individually or combined in any manner.
1) The width of the IBC buffer may be 2^{m} times of the CTU width, where m is a positive integer.
   a. In one example, when the CTU width in luma sample is 256, the IBC buffer width in luma sample may be 256.
   b. In one example, when the CTU width in luma sample is 256, the IBC buffer width in luma sample may be 512.
   c. In one example, when the CTU width in luma sample is 384, the IBC buffer width in luma sample may be 384.
   d. In one example, when the CTU width in luma sample is 384, the IBC buffer width in luma sample may be 384*2.
   e. In one example, when the CTU width in luma sample is 512, the IBC buffer width in luma sample may be 512.
   f. In one example, when the CTU width in luma sample is 512, the IBC buffer width in luma sample may be 512*2.
2) The height of the IBC buffer may be 2″ times of the CTU height, where n is a positive integer.
   a. In one example, when the CTU height in luma sample is 256, the IBC buffer height in luma sample may be 256.
   b. In one example, when the CTU height in luma sample is 256, the IBC buffer height in luma sample may be 512.
3) The width of the IBC buffer may be 2^{k} times of the VPDU width, where k is a positive integer.
   a. In one example, when the VPDU width in luma sample is 128, the IBC buffer width in luma sample may be 128.
   b. In one example, when the VPDU width in luma sample is 128, the IBC buffer width in luma sample may be 256.
   c. In one example, when the VPDU width in luma sample is 128, the IBC buffer width in luma sample may be 512.
   d. In one example, when the VPDU width in luma sample is 256, the IBC buffer width in luma sample may be 256.
   e. In one example, when the VPDU width in luma sample is 256, the IBC buffer width in luma sample may be 512.
   f. In one example, when the VPDU width in luma sample is 256, the IBC buffer width in luma sample may be 1024.
4) The height of the IBC buffer may be 2′ times of the VPDU height, where 1 is a positive integer.
   a. In one example, when the VPDU height in luma sample is 128, the IBC buffer height in luma sample may be 128.
   b. In one example, when the VPDU height in luma sample is 128, the IBC buffer height in luma sample may be 256.
   c. In one example, when the VPDU height in luma sample is 256, the IBC buffer height in luma sample may be 256.
   d. In one example, when the VPDU height in luma sample is 256, the IBC buffer height in luma sample may be 512.
5) When considering IBC buffer, VPDU size may be always be set to be CTU size
   a. In one example, VPDU width may be se to be CTU width.
   b. In one example, VPDU height may be se to be CTU height.
6) The validity check for a block vector may depend on the height of the IBC buffer, which may or may not be equal to be the CTU height.
   a. In one example, the validity of a block vector may be determined by whether the reference block derived from the IBC buffer with parameters of buffer width and height contains invalid sample values.
7) Resetting of the IBC buffer may depend on the height of the IBC buffer, which may or may not be equal to be the CTU height.
   a. In one example, at the beginning of decoding a CTU row in a slice, the resetting of the IBC buffer applies to all samples within the buffer width and height.
   b. In one example, after reconstructing a VPDU, the corresponding block derived from the IBC buffer with parameters of buffer width and height may be reset.
   c. In one example, after reconstructing a CU, the corresponding block derived from the IBC buffer with parameters of buffer width and height may be reset.
   d. In one example, after reconstructing a CTU, the corresponding block derived from the IBC buffer with parameters of buffer width and height may be reset.
8) In above examples, the variables m, n, k, l may be dependent on the CTU width/height.
   a. Alternatively, indication of the value of the variable or the width/height of the IBC buffer may be signalled.
9) In above examples, the variables m and n may be set to same or different values.
   a. Alternatively, whether to set m and n to be same values may depend on whether the CTU width and height are equal.
10) In above examples, the variables k and l may be set to same or different values.
   a. Alternatively, whether to set k and l to be same values may depend on whether the VPDU width and height are equal.

### 5. EMBODIMENTS

Without further mentioned, the following embodiments are based on the specification text described in JVET-T2001-v2. Most relevant parts that have been added or modified are highlighted, and some of the deleted parts are highlighted in. There may be some other changes that are editorial in nature and thus not highlighted.

### 5.1 Embodiment #1

When CTU size in luma sample is 256×256, the following applies:

$$IbcBufWidthY = 256 * 256 / CtbSizeY \qquad ( 45 )$$

$$IbcBufWidthC = IbcBufWidthY / SubWidthC \qquad ( 46 )$$

$$VSize = Min ( 64 , CtbSizeY ) \qquad ( 47 )$$

### 5.2 Embodiment #2

When CTU size in luma sample is 256×256, the following applies:

$$IbcBufWidthY = 512 * 256 / CtbSizeY \qquad ( 45 )$$

$$IbcBufWidthC = IbcBufWidthY / SubWidthC \qquad ( 46 )$$

$$VSize = Min ( 64 , CtbSizeY ) \qquad ( 47 )$$

### 5.3 Embodiment #3

When CTU size in luma sample is 256×256, the following applies:

$$IbcBufWidthY = 512 * 256 / CtbSizeY \qquad ( 45 )$$

$$IbcBufWidthC = IbcBufWidthY / SubWidthC \qquad ( 46 )$$

$$VSize = Min ( 128 , CtbSizeY ) \qquad ( 47 )$$

### 5.4 Embodiment #4

When CTU size in luma sample is 256×256, the following applies:

$$IbcBufWidthY = 512 * 256 / CtbSizeY \qquad ( 45 )$$

$$IbcBufWidthC = IbcBufWidthY / SubWidthC \qquad ( 46 )$$

$$VSize = Min ( 256 , CtbSizeY ) \qquad ( 47 )$$

### 5.5 Embodiment #5

When CTU size in luma sample is 256×256, the following applies:

$$IbcBufWidthY = 512 * 256 / CtbSizeY \qquad ( 45 )$$

$$IbcBufWidthC = IbcBufWidthY / SubWidthC \qquad ( 46 )$$

$$VSize = CtbSizeY \qquad ( 47 )$$

### 5.6 Embodiment #6

When CTU size in luma sample is 256×256, the following applies:

$$IbcBufWidthY = 256 * 128 / CtbSizeY \qquad ( 45 )$$

$$IbcBufWidthC = IbcBufWidthY / SubWidthC \qquad ( 46 )$$

$$VSize = Min ( 64 , CtbSizeY ) \qquad ( 47 )$$

$$IbcBufHeightY = CtbSizeY >> 1$$

8.6.2 Derivation process for block vector components for IBC blocks

### 8.6.2.1 General

Inputs to this process are:
a luma location (xCb, yCb) of the top-left sample of the current luma coding block relative to the top-left luma sample of the current picture,
a variable cbWidth specifying the width of the current coding block in luma samples,
a variable cbHeight specifying the height of the current coding block in luma samples.

Outputs of this process are:
the luma block vector in 1/16 fractional-sample accuracy bvL.

The luma block vector bvL is derived as follows:
The derivation process for IBC luma block vector prediction as specified in clause 8.6.2.2 is invoked with the luma location (xCb, yCb), the variables cbWidth and cbHeight inputs, and the output being the luma block vector bvL.
When general_merge_flag[xCb][yCb] is equal to 0, the following applies:

1. The variable bvd is derived as follows:

$$bvd [ 0 ] = MvdL 0 [ xCb ] [ yCb ] [ 0 ] \qquad ( 1081 )$$

$$bvd [ 1 ] = MvdL 0 [ xCb ] [ yCb ] [ 1 ] \qquad ( 1082 )$$

2. The rounding process for motion vectors as specified in clause 8.5.2.14 is invoked with mvX set equal to bvL, rightShift set equal to AmvrShift, and leftShift set equal to AmvrShift as inputs and the rounded bvL as output.

3. The luma block vector bvL is modified as follows:

$$u [ 0 ] = ( bvL [ 0 ] + bvd [ 0 ] ) \& ( {2}^{18} - 1 ) \qquad ( 1083 )$$

$$bvL [ 0 ] = ( u [ 0 ] >= {2}^{17} ) ? ( u [ 0 ] - {2}^{18} ) : u [ 0 ] \qquad ( 1084 )$$

$$u [ 1 ] = ( bvL [ 1 ] + bvd [ 1 ] ) \& ( {2}^{18} - 1 ) \qquad ( 1085 )$$

$$bvL [ 1 ] = ( u [ 1 ] >= {2}^{17} ) ? ( u [ 1 ] - {2}^{18} ) : u [ 1 ] \qquad ( 1086 )$$

NOTE— The resulting values of bvL[0] and bvL[1] are in the range of −2¹⁷ to 2¹⁷-1, inclusive.

When IsGt4by4 is equal to TRUE, the updating process for the history-based block vector predictor list as specified in clause 8.6.2.6 is invoked with luma block vector bvL.

It is a requirement of bitstream conformance that the luma block vector bvL shall obey the following constraints:
Ibc VirBuf[0][(x+(bvL[0]>>4)) & (IbcBufWidthY−1)][(y+(bvL[1]>>4)) & (IbcBufHeightY−1)] shall not be equal to −1 for x=xCb. . xCb+cbWidth−1 and y=yCb. . yCb+cbHeight−1.

$$……$$

$$xVb = ( xCurr + i ) \% ( ( cIdx == 0 ) ? IbcBufWidthY : IbcBufWidthC ) \qquad ( 1197 )$$

$$yVb = ( yCurr + j ) \% ( ( cIdx == 0 ) ? IbcBufHeightY : IbcBufHeightY / subHeightC ) ) \qquad ( 1198 )$$

$$IbcVirBuf [ cIdx ] [ xVb ] [ yVb ] = recSamples [ xCurr + i ] [ yCurr + j ] \qquad ( 1199 )$$

$$……$$

When cIdx is equal to 0, for x=xCb. . xCb+cbWidth−1 and y=yCb. . yCb+cbHeight−1, the following applies:

$$xVb = ( x + ( bv [ 0 ] >> 4 ) ) \& ( IbcBufWidthY - 1 ) \qquad ( 1096 )$$

$$yVb = ( y + ( bv [ 1 ] >> 4 ) ) \& ( IbcBufHeightY - 1 ) \qquad ( 1097 )$$

$$predSamples [ x - xCb ] [ y - yCb ] = IbcVirBuf [ 0 ] [ xVb ] [ yVb ] \qquad ( 1098 )$$

When cIdx is not equal to 0, for x=xCb/SubWidthC. . xCb/SubWidthC+cbWidth/SubWidthC−1 and y=yCb/SubHeightC. . yCb/SubHeightC+cbHeight/SubHeightC−1, the following applies:

$$xVb = ( x + bv [ 0 ] >> ( 3 + SubWidthC ) ) ) \& ( IbcBufWidthC - 1 ) \qquad ( 1099 )$$

$$yVb = ( y + bv [ 1 ] >> ( 3 + SubHeightC ) ) ) \& ( ( IbcBufHeightY / subHeightC ) - 1 ) \qquad ( 1100 )$$

$$predSamples [ x - ( xCb / SubWidthC ) ] [ y - ( yCb / SubHeightC ) ] = IbcVirBuf [ cIdx ] [ xVb ] [ yVb ] \qquad ( 1101 )$$

As used herein, the term “video unit” used herein may refer to one or more of: a color component, a sub-picture, a slice, a tile, a coding tree unit (CTU), a CTU row, a group of CTUs, a coding unit (CU), a prediction unit (PU), a transform unit (TU), a coding tree block (CTB), a coding block (CB), a prediction block(PB), a transform block (TB), a block, a sub-block of a block, a sub-region within the block, or a region that comprises more than one sample or pixel.

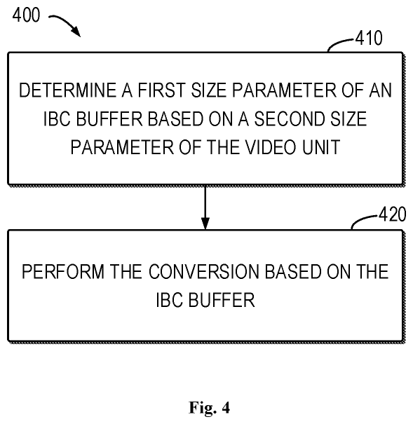

FIG. 4 illustrates a flowchart of a method 400 for video processing in accordance with some embodiments of the present disclosure. The method 400 may be implemented during a conversion between a block and a bitstream of the block.

At block 410, during a conversion between a video unit of a video and a bitstream of the video unit, a first size parameter of an intra block copy (IBC) buffer is determined based on a second size parameter of the video unit. A first value of the first size parameter is an integer multiple of a second value of the second size parameter and the video unit being applied with an IBC mode. In some example embodiments, the first size parameter may refer to a height of the IBC buffer and the second size parameter of the video unit may refer to a height of the video unit. Alternatively, or in addition, the first size parameter may refer to a width of the IBC buffer and the second size parameter of the video unit may refer to a width of the video unit. In some example embodiments, the video unit may comprise a coding tree unit (CTU). Alternatively, or in addition, the video unit may comprise a virtual pipeline data unit (VPDU). In the IBC mode, prediction samples may be derived from blocks of sample values of a same video region as determined by block vectors. The IBC buffer may comprise the blocks of sample values of the same video region, and the prediction samples may be derived from the IBC buffer.

At block 420, the conversion is performed based on the IBC buffer. In some embodiments, the conversion may comprise encoding the video unit into the bitstream. In some embodiments, the conversion may comprise decoding the video unit from the bitstream.

According to embodiments of the present disclosure, the IBC buffer is designed for large sizes of video units, for example, CTU or VPDU. Compared with the conventional solution, embodiments of the present disclosure can advantageously improve the coding efficiency.

Implementations of the present disclosure can be described in view of the following clauses, the features of which can be combined in any reasonable manner.

In some example embodiments, a height of the IBC buffer may be 2″ times of a height of the CTU, wherein n is a positive integer. In some example embodiments, n may depend on the width of the CTU or a height of the CTU. Alternatively, at least one of the followings may be indicated: a value of n, the width of the IBC buffer, or the height of the IBC buffer.

In an example embodiment, if the height of the CTU in luma sample is 256, the height of the IBC buffer in luma sample may be 256. In an example embodiment, if the height of the CTU in luma sample is 256, the height of the IBC buffer in luma sample may be 512.

In some example embodiments, a width of the IBC buffer may be 2 ml times of a width of the CTU, where m is a positive integer. In some example embodiments, m may depend on the width of the CTU or a height of the CTU. Alternatively, at least one of the followings may be indicated: a value of m, the width of the IBC buffer, or the height of the IBC buffer.

In an example embodiment, if the width of the CTU in luma sample is 256, the width of the IBC buffer may be 256. In an example embodiment, if the width of the CTU in luma sample is 256, the width of the IBC buffer may be 512. In an example embodiment, if the width of the CTU in luma sample is 384, the width of the IBC buffer may be 384. In an example embodiment, if the width of the CTU in luma sample is 384, the width of the IBC buffer may be 384*2 (i.e., 768). In an example embodiment, if the width of the CTU in luma sample is 512, the width of the IBC buffer may be 512. In an example embodiment, if the width of the CTU in luma sample is 512, the width of the IBC buffer may be 512*2 (i.e., 1024).

In some example embodiments, a height of the IBC buffer may be 2′ times of a height of the VPDU, where 1 is a positive integer. In some example embodiments, l may depend on the width of the CTU or a height of the CTU. Alternatively, at least one of the followings may be indicated: a value of 1, the width of the IBC buffer, or the height of the IBC buffer.

In an example embodiment, if the height of the VPDU in luma sample is 128, the height of the IBC buffer in luma sample may be 128. In an example embodiment, if the height of the VPDU in luma sample is 128, the height of the IBC buffer in luma sample may be 256. In an example embodiment, if the height of the VPDU in luma sample is 256, the height of the IBC buffer in luma sample may be 256. In an example embodiment, if the height of the VPDU in luma sample is 256, the height of the IBC buffer in luma sample may be 512.

In some example embodiments, a width of the IBC buffer may be 2^{k} times of a width of the VPDU, where k is a positive integer. In some example embodiments, k may depend on the width of the CTU or a height of the CTU. Alternatively, at least one of the followings may be indicated: a value of k, the width of the IBC buffer, or the height of the IBC buffer.

In an example embodiment, if the width of the VPDU in luma sample is 128, the width of the IBC buffer may be 128. In an example embodiment, if the width of the VPDU in luma sample is 128, the width of the IBC buffer may be 256. In an example embodiment, if the width of the VPDU in luma sample is 128, the width of the IBC buffer may be 512. In an example embodiment, if the width of the VPDU in luma sample is 256, the width of the IBC buffer may be 256. In an example embodiment, if the width of the VPDU in luma sample is 256, the width of the IBC buffer may be 512. In an example embodiment, if the width of the VPDU in luma sample is 256, the width of the IBC buffer may be 1024.

In some example embodiments, a validity of a block vector may be determined based on a height of the IBC buffer. In an example embodiment, the height of the IBC buffer may be equal to a height of a CTU associated with the video unit. Alternatively, the height of the IBC buffer may not be equal to the height of the CTU. In other words, the validity check for a block vector may depend on the height of the IBC buffer, which may or may not be equal to be the CTU height. In some example embodiments, a validity of a block vector may be determined based on whether a reference block derived from the IBC buffer with parameters of buffer width and height comprises an invalid sample value. For example, the validity of a block vector may be determined by whether the reference block derived from the IBC buffer with parameters of buffer width and height contains invalid sample values.

In some example embodiments, the IBC buffer may be set based on a height of the IBC buffer. In an example embodiment, the height of the IBC buffer may be equal to a height of a CTU associated with the video unit. Alternatively, the height of the IBC buffer may not be equal to the height of the CTU. For example, resetting of the IBC buffer may depend on the height of the IBC buffer, which may or may not be equal to be the CTU height.

In an example embodiment, at a beginning of decoding a CTU row in a slice of the video, the resetting of the IBC buffer may apply to all samples within buffer width and height. In an example embodiment, after reconstructing a VPDU, a corresponding block derived from the IBC buffer with parameters of buffer width and height may be reset. In an example embodiment, after reconstructing a CU, a corresponding block derived from the IBC buffer with parameters of buffer width and height may be reset. In an example embodiment, after reconstructing a CTU, a corresponding block derived from the IBC buffer with parameters of buffer width and height may be reset.

In some example embodiments, a height of the IBC buffer may be 2″ times of a height of the CTU. In some example embodiments, the width of the IBC buffer may be 2^{m} times of the width of the CTU. In some example embodiments, m and n may be set to a same value. Alternatively, m and n may be set to different values. In some example embodiments, whether to set m and n to be same values may depend on whether the width of the CTU and the height of the CTU are equal.

In some example embodiments, a height of the IBC buffer may be 2′ times of a height of the VPDU. In some example embodiments, the width of the IBC buffer may be 2^{k} times of the width of the VPDU. In some example embodiments, l and k may be set to a same value. Alternatively, l and k may be set to different values. In some example embodiments, whether to set l and k to be same values may depend on whether the width of the VPDU and the height of the VPDU are equal.

In some example embodiments, a size of VPDU may be set to be a size of CTU. In some example embodiments, a width of the VPDU may be set to be a width of the CTU. In some example embodiments, a height of the VPDU may be set to be a height of the CTU.

In some example embodiments, when CTU size in luma sample is 256×256, the following may apply: IbcBufWidthY=256*256/CtbSizeY; IbcBufWidthC=IbcBufWidthY/SubWidthC; VSize=Min(64, CtbSizeY).

In some example embodiments, when CTU size in luma sample is 256×256, the following may apply: IbcBufWidthY=512*256/CtbSizeY; IbcBufWidthC=IbcBufWidthY/SubWidthC; VSize=Min(64, CtbSizeY).

In some example embodiments, when CTU size in luma sample is 256×256, the following may apply: IbcBufWidthY=512 *256/CtbSizeY; IbcBufWidthC=IbcBufWidth Y/SubWidthC; VSize=Min(128, CtbSizeY).

In some example embodiments, when CTU size in luma sample is 256×256, the following may apply: IbcBufWidthY=512*256/CtbSizeY; IbcBufWidthC=IbcBufWidth Y/SubWidthC; VSize=Min(256, CtbSize Y).

In some example embodiments, when CTU size in luma sample is 256×256, the following may apply: IbcBufWidthY=512*256/CtbSizeY; IbcBufWidthC=IbcBufWidthY/SubWidthC; VSize=CtbSizeY.

In some example embodiments, when CTU size in luma sample is 256×256, the following may apply: IbcBufWidthY=256*128/CtbSizeY; IbcBufWidthC=IbcBufWidth Y/SubWidthC; VSize=Min(64, CtbSize Y); IbcBufHeightY=CtbSize Y>>1.

In some example embodiments, the derivation process for block vector components for IBC block may be as shown in Table 3.

TABLE 3
8.6.2 Derivation process for block vector components for IBC blocks
8.6.2.1 General
Inputs to this process are:

| | |
|---|---|
| - | a luma location ( xCb, yCb ) of the top-left sample of the current luma coding block relative to the top-left |
| | luma sample of the current picture, |
| - | a variable cbWidth specifying the width of the current coding block in luma samples, |
| - | a variable cbHeight specifying the height of the current coding block in luma samples. |

Outputs of this process are:

| | |
|---|---|
| - | the luma block vector in 1/16 fractional-sample accuracy bvL. |

The luma block vector bvL is derived as follows:

| - | The derivation process for IBC luma block vector prediction as specified in clause 8.6.2.2 is invoked with | |
|---|---|---|
| | the luma location ( xCb, yCb ), the variables cbWidth and cbHeight inputs, and the output being the luma | |
| | block vector bvL. | |
| - | When general_merge_flag[ xCb ][ yCb ] is equal to 0, the following applies: | |
| | 4. | The variable bvd is derived as follows: |

| | |
|---|---|
| bvd[ 0 ] = MvdL0[ xCb ][ yCb ][ 0 ] | (1081) |
| bvd[ 1 ] = MvdL0[ xCb ][ yCb ][ 1 ] | (1082) |

| | |
|---|---|
| 5. | The rounding process for motion vectors as specified in clause 8.5.2.14 is invoked with mvX set |
| | equal to bvL, rightShift set equal to AmvrShift, and leftShift set equal to AmvrShift as inputs and |
| | the rounded bvL as output. |
| 6. | The luma block vector bvL is modified as follows: |
| | u[ 0 ] = ( bvL[ 0 ] + bvd[ 0 ] ) & ( 2¹⁸ − 1 ) |
| | (1083) |

| bvL[ 0 ] = ( u[ 0 ] >= 2¹⁷ ) ? ( u[ 0 ] − 2¹⁸ ) : u[ 0 ] | (1084) |
|---|---|
| u[ 1 ] = ( bvL[ 1 ] + bvd[ 1 ] ) & ( 2¹⁸ − 1 ) | |
| (1085) | |
| bvL[ 1 ] = ( u[ 1 ] >= 2¹⁷ ) ? ( u[ 1 ] − 2¹⁸ ) : u[ 1 ] | (1086) |

NOTE - The resulting values of bvL[ 0 ] and bvL[ 1 ] are in the range of −2¹⁷ to 2¹⁷ − 1, inclusive.

When IsGt4by4 is equal to TRUE, the updating process for the history-based block vector predictor list as
specified in clause 8.6.2.6 is invoked with luma block vector bvL.
It is a requirement of bitstream conformance that the luma block vector bvL shall obey the following constraints:

| | |
|---|---|
| - | IbcVirBuf[ 0 ][ ( x + (bvL[ 0 ] >> 4 ) ) & ( IbcBufWidthY − 1 ) ][ ( y + (bvL[ 1 ] >> 4 ) ) & ( IbcBufH |
| | eightY − 1 ) ] shall not be equal to −1 for x = xCb..xCb + cb Width − 1 and y = yCb..yCb + cbHeight − 1. |

......

| | |
|---|---|
| xVb = ( xCurr + i ) % ( ( cIdx = = 0 ) ? IbcBufWidthY : IbcBufWidthC ) | (1197) |
| yVb = ( yCurr + j ) % ( ( cIdx = = 0 ) ? IbcBufHeightY : ( IbcBufHeightY / subHeightC ) ) | (1198) |
| IbcVirBuf[ cIdx ][ xVb ][ yVb ] = recSamples[ xCurr + i ][ yCurr + j ] | (1199) |

......
When cIdx is equal to 0, for x = xCb..xCb + cbWidth − 1 and y = yCb..yCb + cbHeight − 1, the following
applies:

| | |
|---|---|
| xVb = ( x + ( bv[ 0 ] >> 4 ) ) & ( IbcBufWidthY − 1 ) | (1096) |

yVb = ( y + ( bv[ 1 ] >> 4 ) ) & ( IbcBufHeightY − 1 )

(1097)

| | |
|---|---|
| predSamples[ x − xCb ][ y − yCb ] = IbcVirBuf[ 0 ][ xVb ][ yVb ] | (1098) |

When cIdx is not equal to 0, for x = xCb / SubWidthC..xCb / SubWidthC + cbWidth / SubWidthC − 1 and
y = yCb / SubHeightC..yCb / SubHeightC + cbHeight / SubHeightC − 1, the following applies:

| | |
|---|---|
| xVb = ( x + ( bv[ 0 ] >> ( 3 + SubWidthC ) ) ) & ( IbcBufWidthC − 1 ) | (1099) |
| yVb = ( y + ( bv[ 1 ] >> ( 3 + SubHeightC ) ) ) & ( ( IbcBufHeightY / subHeightC ) − 1 ) | (1100) |

predSamples[ x − ( xCb / SubWidthC ) ][ y − ( yCb / SubHeightC ) ] = IbcVirBuf[ cIdx ][ xVb ][ yVb ]

(1101)

Embodiments of the present disclosure can be implemented separately. Alternatively, embodiments of the present disclosure can be implemented in any proper combinations. Implementations of the present disclosure can be described in view of the following clauses, the features of which can be combined in any reasonable manner.

Clause 1. A method of video processing, comprising: determining, during a conversion between a video unit of a video and a bitstream of the video unit, a first size parameter of an intra block copy (IBC) buffer based on a second size parameter of the video unit, a first value of the first size parameter being an integer multiple of a second value of the second size parameter and the video unit being applied with an IBC mode; and performing the conversion based on the IBC buffer.

Clause 2. The method of clause 1, wherein the video unit is a coding tree unit (CTU).

Clause 3. The method of clause 2, wherein determining the first size parameter of the IBC buffer based on the second size parameter of the video unit comprises: determining that a height of the IBC buffer is 2″ times of a height of the CTU, wherein n is a positive integer.

Clause 4. The method of clause 3, wherein n depends on the width of the CTU or a height of the CTU, or wherein at least one of the followings is indicated: a value of n, the width of the IBC buffer, or the height of the IBC buffer.

Clause 5. The method of clause 3, wherein if the height of the CTU in luma sample is 256, the height of the IBC buffer in luma sample is 256.

Clause 6. The method of clause 3, wherein if the height of the CTU in luma sample is 256, the height of the IBC buffer in luma sample is 512.

Clause 7. The method of clause 2, wherein determining the first size parameter of the IBC buffer based on the second size parameter of the video unit comprises: determining that a width of the IBC buffer is 2^{m} times of a width of the CTU, wherein m is a positive integer.

Clause 8. The method of clause 7, wherein m depends on the width of the CTU or a height of the CTU, or wherein at least one of the followings is indicated: a value of m, the width of the IBC buffer, or the height of the IBC buffer.

Clause 9. The method of clause 7, wherein the if the width of the CTU in luma sample is 256, the width of the IBC buffer is 256.

Clause 10. The method of clause 7, wherein if the width of the CTU in luma sample is 256, the width of the IBC buffer is 512.

Clause 11. The method of clause 7, wherein if the width of the CTU in luma sample is 384, the width of the IBC buffer is 384.

Clause 12. The method of clause 7, wherein if the width of the CTU in luma sample is 384, the width of the IBC buffer is 768.

Clause 13. The method of clause 7, wherein if the width of the CTU in luma sample is 512, the width of the IBC buffer is 512.

Clause 14. The method of clause 7, wherein if the width of the CTU in luma sample is 512, the width of the IBC buffer is 1024.

Clause 15. The method of clause 1, wherein the video unit is a virtual pipeline data unit (VPDU).

Clause 16. The method of clause 15, wherein determining the first size parameter of the IBC buffer based on the second size parameter of the video unit comprises: determining that a height of the IBC buffer is 2′ times of a height of the VPDU, wherein 1 is a positive integer.

Clause 17. The method of clause 16, wherein l depends on the width of the CTU or a height of the CTU, or wherein at least one of the followings is indicated: a value of 1, the width of the IBC buffer, or the height of the IBC buffer.

Clause 18. The method of clause 16, wherein if the height of the VPDU in luma sample is 128, the height of the IBC buffer in luma sample is 128.

Clause 19. The method of clause 16, wherein if the height of the VPDU in luma sample is 128, the height of the IBC buffer in luma sample is 256.

Clause 20. The method of clause 16, wherein if the height of the VPDU in luma sample is 256, the height of the IBC buffer in luma sample is 256.

Clause 21. The method of clause 16, wherein if the height of the VPDU in luma sample is 256, the height of the IBC buffer in luma sample is 512.

Clause 22. The method of clause 15, wherein determining the first size parameter of the IBC buffer based on the second size parameter of the video unit comprises: determining that a width of the IBC buffer is 2^{k} times of a width of the VPDU, wherein k is a positive integer.

Clause 23. The method of clause 22, wherein k depends on the width of the CTU or a height of the CTU, or wherein at least one of the followings is indicated: a value of k, the width of the IBC buffer, or the height of the IBC buffer.

Clause 24. The method of clause 22, wherein if the width of the VPDU in luma sample is 128, the width of the IBC buffer is 128.

Clause 25. The method of clause 22, wherein if the width of the VPDU in luma sample is 128, the width of the IBC buffer is 256.

Clause 26. The method of clause 22, wherein if the width of the VPDU in luma sample is 128, the width of the IBC buffer is 512.

Clause 27. The method of clause 22, wherein if the width of the VPDU in luma sample is 256, the width of the IBC buffer is 256.

Clause 28. The method of clause 22, wherein if the width of the VPDU in luma sample is 256, the width of the IBC buffer is 512.

Clause 29. The method of clause 22, wherein if the width of the VPDU in luma sample is 256, the width of the IBC buffer is 1024.

Clause 30. The method of clause 1, further comprising: determining a validity of a block vector based on a height of the IBC buffer, wherein the height of the IBC buffer is equal to a height of a CTU associated with the video unit, or the height of the IBC buffer is not equal to the height of the CTU.

Clause 31. The method of clause 1, further comprising: determining a validity of a block vector based on whether a reference block derived from the IBC buffer with parameters of buffer width and height comprises an invalid sample value.

Clause 32. The method clause 1, further comprising: resetting the IBC buffer based on a height of the IBC buffer, wherein the height of the IBC buffer is equal to a height of a CTU associated with the video unit, or the height of the IBC buffer is not equal to the height of the CTU.

Clause 33. The method of clause 32, wherein at a beginning of decoding a CTU row in a slice of the video, the resetting of the IBC buffer applies to all samples within buffer width and height.

Clause 34. The method of clause 32, further comprising: after reconstructing a VPDU, resetting a corresponding block derived from the IBC buffer with parameters of buffer width and height.

Clause 35. The method of clause 32, further comprising: after reconstructing a CU, resetting a corresponding block derived from the IBC buffer with parameters of buffer width and height.

Clause 36. The method of clause 32, further comprising: after reconstructing a CTU, resetting a corresponding block derived from the IBC buffer with parameters of buffer width and height.

Clause 37. The method of clause 1, wherein a height of the IBC buffer is 2″ times of a height of the CTU, or the width of the IBC buffer is 2″ times of the width of the CTU, wherein m and n are set to a same value or different values, or wherein whether to set m and n to be same values depends on whether the width of the CTU and the height of the CTU are equal.

Clause 38. The method of clause 1, wherein a height of the IBC buffer is 2′ times of a height of the VPDU, or the width of the IBC buffer is 2^{k} times of the width of the VPDU, wherein l and k are set to a same value or different values, or wherein whether to set l and k to be same values depends on whether the width of the VPDU and the height of the VPDU are equal.

Clause 39. The method of clause 1, wherein a size of VPDU is set to be a size of CTU.

Clause 40. The method of clause 1, wherein a width of the VPDU is set to be a width of the CTU.

Clause 41. The method of clause 1, wherein a height of the VPDU is set to be a height of the CTU.

Clause 42. The method of any of clauses 1-41, wherein the conversion includes encoding the target block into the bitstream.

Clause 43. The method of any of clauses 1-41, wherein the conversion includes decoding the target block from the bitstream.

Clause 44. The method of any of clauses 1-41, wherein in the IBC mode, prediction samples are derived from blocks of sample values of a same video region as determined by block vectors.

Clause 45. The method of any of clauses 1-41, wherein the IBC buffer comprises the blocks of sample values of the same video region, and the prediction samples are derived from the IBC buffer.

Clause 46. An apparatus for processing video data comprising a processor and a non-transitory memory with instructions thereon, wherein the instructions upon execution by the processor, cause the processor to perform a method in accordance with any of clauses 1-45.

Clause 47. A non-transitory computer-readable storage medium storing instructions that cause a processor to perform a method in accordance with any of clauses 1-45.

Clause 48. A non-transitory computer-readable recording medium storing a bitstream of a video which is generated by a method performed by a video processing apparatus, wherein the method comprises: determining a first size parameter of an intra block copy (IBC) buffer based on a second size parameter of a video unit of the video, a first value of the first size parameter being an integer multiple of a second value of the second size parameter and the video unit being applied with an IBC mode; and generating a bitstream of the video unit based on the IBC buffer.

Clause 49. A method for storing bitstream of a video, comprising: determining a first size parameter of an intra block copy (IBC) buffer based on a second size parameter of a video unit of the video, a first value of the first size parameter being an integer multiple of a second value of the second size parameter and the video unit being applied with an IBC mode; generating a bitstream of the video unit based on the IBC buffer; and storing the bitstream in a non-transitory computer-readable recording medium.

### Example Device

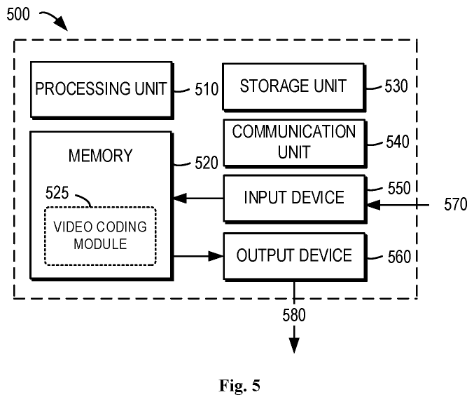

FIG. 5 illustrates a block diagram of a computing device 500 in which various embodiments of the present disclosure can be implemented. The computing device 500 may be implemented as or included in the source device 110 (or the video encoder 114 or 200) or the destination device 120 (or the video decoder 124 or 300).

It would be appreciated that the computing device 500 shown in FIG. 5 is merely for purpose of illustration, without suggesting any limitation to the functions and scopes of the embodiments of the present disclosure in any manner.

As shown in FIG. 5, the computing device 500 includes a general-purpose computing device 500. The computing device 500 may at least comprise one or more processors or processing units 510, a memory 520, a storage unit 530, one or more communication units 540, one or more input devices 550, and one or more output devices 560.

In some embodiments, the computing device 500 may be implemented as any user terminal or server terminal having the computing capability. The server terminal may be a server, a large-scale computing device or the like that is provided by a service provider. The user terminal may for example be any type of mobile terminal, fixed terminal, or portable terminal, including a mobile phone, station, unit, device, multimedia computer, multimedia tablet, Internet node, communicator, desktop computer, laptop computer, notebook computer, netbook computer, tablet computer, personal communication system (PCS) device, personal navigation device, personal digital assistant (PDA), audio/video player, digital camera/video camera, positioning device, television receiver, radio broadcast receiver, E-book device, gaming device, or any combination thereof, including the accessories and peripherals of these devices, or any combination thereof. It would be contemplated that the computing device 500 can support any type of interface to a user (such as “wearable” circuitry and the like).

The processing unit 510 may be a physical or virtual processor and can implement various processes based on programs stored in the memory 520. In a multi-processor system, multiple processing units execute computer executable instructions in parallel so as to improve the parallel processing capability of the computing device 500. The processing unit 510 may also be referred to as a central processing unit (CPU), a microprocessor, a controller or a microcontroller.

The computing device 500 typically includes various computer storage medium. Such medium can be any medium accessible by the computing device 500, including, but not limited to, volatile and non-volatile medium, or detachable and non-detachable medium. The memory 520 can be a volatile memory (for example, a register, cache, Random Access Memory (RAM)), a non-volatile memory (such as a Read-Only Memory (ROM), Electrically Erasable Programmable Read-Only Memory (EEPROM), or a flash memory), or any combination thereof. The storage unit 530 may be any detachable or non-detachable medium and may include a machine-readable medium such as a memory, flash memory drive, magnetic disk or another other media, which can be used for storing information and/or data and can be accessed in the computing device 500.

The computing device 500 may further include additional detachable/non-detachable, volatile/non-volatile memory medium. Although not shown in FIG. 5, it is possible to provide a magnetic disk drive for reading from and/or writing into a detachable and non-volatile magnetic disk and an optical disk drive for reading from and/or writing into a detachable non-volatile optical disk. In such cases, each drive may be connected to a bus (not shown) via one or more data medium interfaces.

The communication unit 540 communicates with a further computing device via the communication medium. In addition, the functions of the components in the computing device 500 can be implemented by a single computing cluster or multiple computing machines that can communicate via communication connections. Therefore, the computing device 500 can operate in a networked environment using a logical connection with one or more other servers, networked personal computers (PCs) or further general network nodes.

The input device 550 may be one or more of a variety of input devices, such as a mouse, keyboard, tracking ball, voice-input device, and the like. The output device 560 may be one or more of a variety of output devices, such as a display, loudspeaker, printer, and the like. By means of the communication unit 540, the computing device 500 can further communicate with one or more external devices (not shown) such as the storage devices and display device, with one or more devices enabling the user to interact with the computing device 500, or any devices (such as a network card, a modem and the like) enabling the computing device 500 to communicate with one or more other computing devices, if required. Such communication can be performed via input/output (I/O) interfaces (not shown).

In some embodiments, instead of being integrated in a single device, some or all components of the computing device 500 may also be arranged in cloud computing architecture. In the cloud computing architecture, the components may be provided remotely and work together to implement the functionalities described in the present disclosure. In some embodiments, cloud computing provides computing, software, data access and storage service, which will not require end users to be aware of the physical locations or configurations of the systems or hardware providing these services. In various embodiments, the cloud computing provides the services via a wide area network (such as Internet) using suitable protocols. For example, a cloud computing provider provides applications over the wide area network, which can be accessed through a web browser or any other computing components. The software or components of the cloud computing architecture and corresponding data may be stored on a server at a remote position. The computing resources in the cloud computing environment may be merged or distributed at locations in a remote data center. Cloud computing infrastructures may provide the services through a shared data center, though they behave as a single access point for the users. Therefore, the cloud computing architectures may be used to provide the components and functionalities described herein from a service provider at a remote location. Alternatively, they may be provided from a conventional server or installed directly or otherwise on a client device.

The computing device 500 may be used to implement video encoding/decoding in embodiments of the present disclosure. The memory 520 may include one or more video coding modules 525 having one or more program instructions. These modules are accessible and executable by the processing unit 510 to perform the functionalities of the various embodiments described herein.

In the example embodiments of performing video encoding, the input device 550 may receive video data as an input 570 to be encoded. The video data may be processed, for example, by the video coding module 525, to generate an encoded bitstream. The encoded bitstream may be provided via the output device 560 as an output 580.

In the example embodiments of performing video decoding, the input device 550 may receive an encoded bitstream as the input 570. The encoded bitstream may be processed, for example, by the video coding module 525, to generate decoded video data. The decoded video data may be provided via the output device 560 as the output 580.

While this disclosure has been particularly shown and described with references to preferred embodiments thereof, it will be understood by those skilled in the art that various changes in form and details may be made therein without departing from the spirit and scope of the present application as defined by the appended claims. Such variations are intended to be covered by the scope of this present application. As such, the foregoing description of embodiments of the present application is not intended to be limiting.

I/We claim:

1. A method of video processing, comprising:
determining, during a conversion between a video unit of a video and a bitstream of the video unit, a first size parameter of an intra block copy (IBC) buffer based on a second size parameter of the video unit, a first value of the first size parameter being an integer multiple of a second value of the second size parameter and the video unit being applied with an IBC mode; and
performing the conversion based on the IBC buffer.

2. The method of claim 1, wherein the video unit is a coding tree unit (CTU), and wherein determining the first size parameter of the IBC buffer based on the second size parameter of the video unit comprises:
determining that a height of the IBC buffer is 2″ times of a height of a coding tree unit (CTU), wherein n is a positive integer, and
wherein n depends on the width of the CTU or a height of the CTU, or
wherein at least one of the followings is indicated:
a value of n,
the width of the IBC buffer, or
the height of the IBC buffer.

3. The method of claim 2, wherein if the height of the CTU in luma sample is 256, the height of the IBC buffer in luma sample is 512, or
wherein if the height of the CTU in luma sample is 256, the height of the IBC buffer in luma sample is 256.

4. The method of claim 1, wherein the video unit is a coding tree unit (CTU), and wherein determining the first size parameter of the IBC buffer based on the second size parameter of the video unit comprises:
determining that a width of the IBC buffer is 2″ times of a width of the CTU, wherein m is a positive integer, and
wherein m depends on the width of the CTU or a height of the CTU, or
wherein at least one of the followings is indicated:
a value of m,
the width of the IBC buffer, or
the height of the IBC buffer.

5. The method of claim 4, wherein the if the width of the CTU in luma sample is 256, the width of the IBC buffer is 256, or
wherein if the width of the CTU in luma sample is 256, the width of the IBC buffer is 512, or
wherein if the width of the CTU in luma sample is 384, the width of the IBC buffer is 384, or
wherein if the width of the CTU in luma sample is 384, the width of the IBC buffer is 768, or
wherein if the width of the CTU in luma sample is 512, the width of the IBC buffer is 512, or
wherein if the width of the CTU in luma sample is 512, the width of the IBC buffer is 1024.

6. The method of claim 1, wherein the video unit is a virtual pipeline data unit (VPDU), and wherein determining the first size parameter of the IBC buffer based on the second size parameter of the video unit comprises:
determining that a height of the IBC buffer is 2′ times of a height of the VPDU, wherein 1 is a positive integer, and
wherein l depends on the width of the CTU or a height of the CTU, or
wherein at least one of the followings is indicated:
a value of 1,
the width of the IBC buffer, or
the height of the IBC buffer.

7. The method of claim 6, wherein if the height of the VPDU in luma sample is 128, the height of the IBC buffer in luma sample is 128, or
wherein if the height of the VPDU in luma sample is 128, the height of the IBC buffer in luma sample is 256, or
wherein if the height of the VPDU in luma sample is 256, the height of the IBC buffer in luma sample is 256, or
wherein if the height of the VPDU in luma sample is 256, the height of the IBC buffer in luma sample is 512.

8. The method of claim 1, wherein the video unit is a virtual pipeline data unit (VPDU), and wherein determining the first size parameter of the IBC buffer based on the second size parameter of the video unit comprises:
determining that a width of the IBC buffer is 2^{k} times of a width of the VPDU, wherein k is a positive integer, and
wherein k depends on the width of the CTU or a height of the CTU, or
wherein at least one of the followings is indicated:
a value of k,
the width of the IBC buffer, or
the height of the IBC buffer.

9. The method of claim 8, wherein if the width of the VPDU in luma sample is 128, the width of the IBC buffer is 128, or
wherein if the width of the VPDU in luma sample is 128, the width of the IBC buffer is 256, or
wherein if the width of the VPDU in luma sample is 128, the width of the IBC buffer is 512, or
wherein if the width of the VPDU in luma sample is 256, the width of the IBC buffer is 256, or
wherein if the width of the VPDU in luma sample is 256, the width of the IBC buffer is 512, or
wherein if the width of the VPDU in luma sample is 256, the width of the IBC buffer is 1024.

10. The method of claim 1, further comprising:
determining a validity of a block vector based on a height of the IBC buffer, wherein the height of the IBC buffer is equal to a height of a CTU associated with the video unit, or the height of the IBC buffer is not equal to the height of the CTU.

11. The method of claim 1, further comprising:
determining a validity of a block vector based on whether a reference block derived from the IBC buffer with parameters of buffer width and height comprises an invalid sample value.

12. The method of claim 1, further comprising:
resetting the IBC buffer based on a height of the IBC buffer, wherein the height of the IBC buffer is equal to a height of a CTU associated with the video unit, or the height of the IBC buffer is not equal to the height of the CTU.

13. The method of claim 12, wherein at a beginning of decoding a CTU row in a slice of the video, the resetting of the IBC buffer applies to all samples within buffer width and height.

14. The method of claim 12, further comprising:
after reconstructing a VPDU, resetting a corresponding block derived from the IBC buffer with parameters of buffer width and height, or
after reconstructing a CU, resetting a corresponding block derived from the IBC buffer with parameters of buffer width and height, or
after reconstructing a CTU, resetting a corresponding block derived from the IBC buffer with parameters of buffer width and height.

15. The method of claim 1, wherein a height of the IBC buffer is 2″ times of a height of the CTU, or the width of the IBC buffer is 2^{m} times of the width of the CTU,
wherein m and n are set to a same value or different values, or
wherein whether to set m and n to be same values depends on whether the width of the CTU and the height of the CTU are equal, and/or
wherein a height of the IBC buffer is 2′ times of a height of the VPDU, or the width of the IBC buffer is 2^{k} times of the width of the VPDU,
wherein l and k are set to a same value or different values, or
wherein whether to set l and k to be same values depends on whether the width of the VPDU and the height of the VPDU are equal.

16. The method of claim 1, wherein a size of VPDU is set to be a size of CTU, or
wherein a width of the VPDU is set to be a width of the CTU, or
wherein a height of the VPDU is set to be a height of the CTU.

17. The method of claim 1, wherein the conversion includes encoding the target block into the bitstream, or
wherein the conversion includes decoding the target block from the bitstream.

18. An apparatus for processing video data comprising a processor and a non-transitory memory with instructions thereon, wherein the instructions upon execution by the processor, cause the processor to:
determine, during a conversion between a video unit of a video and a bitstream of the video unit, a first size parameter of an intra block copy (IBC) buffer based on a second size parameter of the video unit, a first value of the first size parameter being an integer multiple of a second value of the second size parameter and the video unit being applied with an IBC mode; and
perform the conversion based on the IBC buffer.

19. A non-transitory computer-readable storage medium storing instructions that cause a processor to:
determine, during a conversion between a video unit of a video and a bitstream of the video unit, a first size parameter of an intra block copy (IBC) buffer based on a second size parameter of the video unit, a first value of the first size parameter being an integer multiple of a second value of the second size parameter and the video unit being applied with an IBC mode; and
perform the conversion based on the IBC buffer.

20. A non-transitory computer-readable recording medium storing a bitstream of a video which is generated by a method performed by a video processing apparatus, wherein the method comprises:
determining a first size parameter of an intra block copy (IBC) buffer based on a second size parameter of a video unit of the video, a first value of the first size parameter being an integer multiple of a second value of the second size parameter and the video unit being applied with an IBC mode; and
generating a bitstream of the video unit based on the IBC buffer.
